(19) United States
(12) Patent Application Publication
(10) Pub. No.: US 2026/0221362 A1
(43) Pub. Date: Jul. 30, 2026

(54) HIGH VOLTAGE RELAY WITH VOLTAGE SAMPLING

(71) Applicant: FCA US LLC, Auburn Hills, MI (US)

(72) Inventors: Zhenqiang Sun, Shanghai (CN); Xiao Ping Mao, Shanghai (CN); RunJie Yang, Shanghai (CN)

(21) Appl. No.: 19/040,990

(22) Filed: Jan. 30, 2025

(51) Int. Cl. H01H 50/54; B60R 16/02; H01H 50/02; H01H 51/01

(52) U.S. Cl. CPC H01H 50/546; B60R 16/0207; H01H 50/026; H01H 50/541; H01H 51/01

(57) ABSTRACT

A relay assembly of a battery disconnect unit (BDU) of an electrified vehicle high voltage (HV) battery system includes a housing defining a contactor compartment and a coil compartment separated by a barrier, a first fixed contactor at least partially disposed within the contactor compartment and configured as an input to the relay assembly, a second fixed contactor at least partially disposed within the contactor compartment and configured as an output of the relay assembly, a movable contactor assembly configured to selectively electrically connect the first fixed contactor and the second fixed contactor, and an integrated voltage sampler configured to measure a voltage on the first and second fixed contactors.

### FIELD

The present application relates generally to electrified vehicles and, more particularly, to a high voltage relay with a voltage sampling function.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system includes a battery disconnect unit (BDU) that has individual busbar circuits from the BDU to several high voltage connectors to exterior sections of the high voltage battery pack. These connections are available to control and manage many different device connections in the vehicle. Additional components/features require space that presents weight and packaging challenges that add complexity and increase cost. Accordingly, while such conventional systems do work well for their intended purpose, there remains a need for improvement in the relevant art.

### SUMMARY

In accordance with one example aspect of the invention, a relay assembly of a battery disconnect unit (BDU) of an electrified vehicle high voltage (HV) battery system is provided. In one example implementation, the relay assembly includes a housing defining a contactor compartment and a coil compartment separated by a barrier, a first fixed contactor at least partially disposed within the contactor compartment and configured as an input to the relay assembly, a second fixed contactor at least partially disposed within the contactor compartment and configured as an output of the relay assembly, a movable contactor assembly configured to selectively electrically connect the first fixed contactor and the second fixed contactor, and an integrated voltage sampler configured to measure a voltage on the first and second fixed contactors.

In addition to the foregoing, the described relay assembly may include one or more of the following features: wherein the voltage sampler includes a pair of voltage measurement lines electrically connected to the first and second fixed contactors; wherein the voltage sampler further includes an electrical connector electrically coupled to the pair of voltage measurement lines, wherein the electrical connector is configured to provide one or more signals indicative of the measured voltage; wherein at least a portion of each voltage measurement line is disposed within a wall of the housing; and wherein each voltage measurement line is a metallic sheet.

In addition to the foregoing, the described relay assembly may include one or more of the following features: a relay control configured to selectively provide a control current to the movable contactor assembly; wherein the first and second fixed contactors extend through the housing into the contactor compartment; wherein the movable contactor assembly includes a coil assembly, and a movable contactor configured to selectively move into contact with the first and second fixed contactors when the coil assembly is energized; and wherein the coil assembly includes a magnetic core with a coil wound thereon, and wherein the movable contactor is coupled to a pin that extends through the barrier and into the coil assembly.

In accordance with another example aspect of the invention, a high voltage (HV) battery system for an electrified vehicle is provided. In one example implementation, the HV battery system includes a HV battery, a HV bus configured to provide power to an electric drive module (EDM), and a battery disconnect unit (BDU) having a relay assembly configured to selectively connect the HV battery to the HV bus, wherein the relay assembly includes an integrated voltage sampler configured to measure a voltage on the relay assembly.

In addition to the foregoing, the described HV battery system may include one or more of the following features: a housing defining a contactor compartment and a coil compartment separated by a barrier, a first fixed contactor at least partially disposed within the contactor compartment and configured as an input to the relay assembly, a second fixed contactor at least partially disposed within the contactor compartment and configured as an output of the relay assembly, and a movable contactor assembly configured to selectively electrically connect the first fixed contactor and the second fixed contactor. The integrated voltage sampler is configured to measure a voltage on the first and second fixed contactors.

In addition to the foregoing, the described HV battery system may include one or more of the following features: wherein the voltage sampler includes a pair of voltage measurement lines electrically connected to the first and second fixed contactors; wherein the voltage sampler further includes an electrical connector electrically coupled to the pair of voltage measurement lines, wherein the electrical connector is configured to provide one or more signals indicative of the measured voltage; a battery management system (BMS) controller in signal communication with the voltage sampler electrical connector; wherein at least a portion of each voltage measurement line is disposed within a wall of the housing; and wherein each voltage measurement line is a metallic sheet.

In addition to the foregoing, the described HV battery system may include one or more of the following features: a relay control configured to selectively provide a control current to the movable contactor assembly; wherein the first and second fixed contactors extend through the housing into the contactor compartment; wherein the movable contactor assembly a coil assembly, and a movable contactor configured to selectively move into contact with the first and second fixed contactors when the coil assembly is energized; and wherein the coil assembly includes a magnetic core with a coil wound thereon, and wherein the movable contactor is coupled to a pin that extends through the barrier and into the coil assembly.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of an electrified vehicle having a high voltage battery system in accordance with the principles of the present disclosure; and

FIG. 2 is a side sectional view of an example relay assembly of the high voltage battery system, in accordance with the principles of the present disclosure.

### DESCRIPTION

As previously discussed, electrified vehicles (EVs) typically include an electrified powertrain with one or more electric traction motors powered by a high voltage (HV) battery system. The HV battery system is selectively connected to a HV bus by a battery disconnect unit (BDU), which typically includes some form of relay, fuse, resistor, and other parts connected via a complex busbar. Additional features, such as a voltage sampling function, require complex connections and take up packaging space. Thus, such designs require a lot of packaging space, present weight challenges that add assembly complexity, and increase costs.

Accordingly, described herein are systems and methods for a HV battery system BDU having a relay assembly with a voltage sampling function that minimizes packaging volume, simplifies electrical connections, and reduces material usage. In general, the relay assembly includes a voltage sampling assembly in the fixed contact and is configured to send both voltage sample value signals and relay status/drive signals to the battery management system (BMS). In this way, the HV battery system does not require a separate dedicated voltage sampler, thereby reducing system complexity and cost.

In one example, relay assembly includes a voltage sampler electrically connected to the input and output fixed contacts (busbars) of the relay assembly. The voltage sampler is configured to determine whether the relay assembly is open or closed based on the voltage sampling signals from a first electrical connection to the input fixed contact and a second electrical connection to the output fixed contact. A relay control is configured to selectively move a movable contactor into contact with the fixed contacts to establish an electrical connection therebetween. A wire harness is configured to connect the voltage sampler and the relay control to the BMS to thereby provide the voltage sample and relay assembly status to the BMS. As such, the relay assembly integrates main bus and fast charge switch function in the circuit to thereby provide an improved layout with minimized material usage.

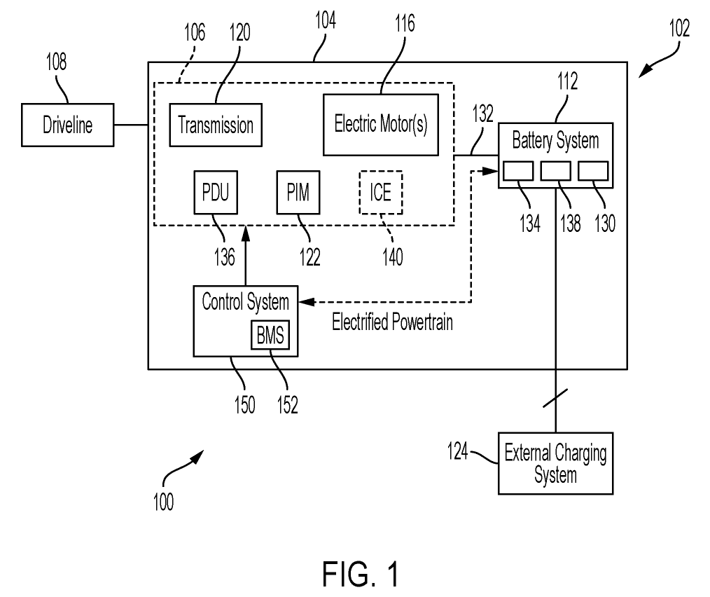

Referring now to FIG. 1, a functional block diagram of an electrified vehicle 100 having an example high voltage (HV) battery control system 102 according to the principles of the present application is illustrated. The vehicle 100 includes an electrified powertrain 104 having one or more electric drive modules (EDMs) 106 configured to generate and transfer drive torque to a driveline 108 for vehicle propulsion. The electrified powertrain 104 is configured to utilize electrical energy from a high voltage battery system 112. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 122 to the high voltage (HV) battery system 112 for powering the electric motor 116. The high voltage battery system 112 is selectively connectable (e.g., by the driver) to an external charging system 124 (also referred to herein as “charger 124”) for charging of the battery system 112. The HV battery system 112 includes at least one battery pack assembly 130 configured to be selectively connected to a HV bus 132 or the charger 124 via a battery disconnect unit (BDU) 134, as described herein in more detail. The HV bus 132 is electrically connected to the EDM 106 and a power distribution unit (PDU) 136, which is configured to provide power to additional HV loads (not shown). As described herein in more detail, the HV battery system 112 also includes a relay assembly 138, which may be part of the BDU 134.

In some examples, the electrified powertrain 104 can be a hybrid powertrain that additionally includes an internal combustion engine 140. A control system or controller 150 is configured to control the electrified powertrain 104 and can provide various inputs to the EDM 106 related to selectively switching power inputs between the electric motors 116 and, optionally, the engine 140. The control system 150, which can include a battery management system 152, is also configured to control the relay assembly 138 (FIG. 3) of the BDU 134 to selectively connect the HV battery pack assembly 130 to the EDM 106 and the PDU 136 via the HV bus 132, as described herein in more detail.

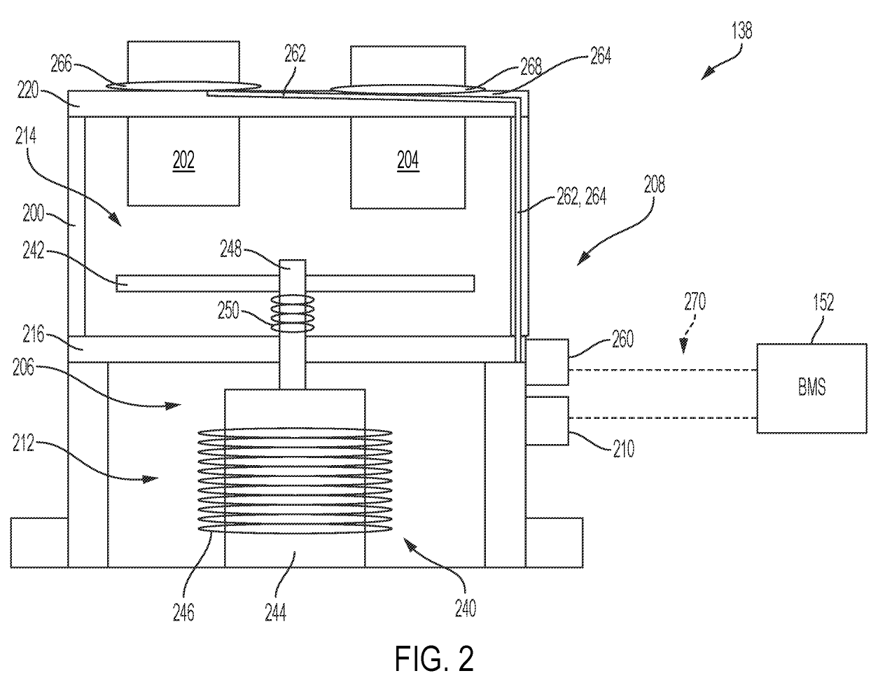

With reference now to FIG. 2, an example embodiment of the relay assembly 138 is illustrated according to the principles of the present application. In the example embodiment, the relay assembly 138 generally includes a housing 200, a pair of fixed electrical contactors 202, 204, a movable contactor assembly 206, a voltage sampler 208, and a relay control 210. The housing 200 generally defines a coil compartment 212 and a contactor compartment 214 separated by a wall or barrier 216. In one example, the coil compartment 212 may be made of a plastic material, and the contactor compartment 214 may be made of a ceramic material.

In the example embodiment, the first fixed contactor 202 extends through a top wall 220 and is configured as an input contactor configured to electrically couple to the HV battery pack 130. The second fixed contactor 204 extends through the top wall 220 and is configured as an output contactor configured to electrically couple to the HV bus 132 with the EDM 106 and PDU 136.

In the example implementation, the movable contactor assembly 206 generally includes a coil assembly 240 and a movable contactor 242. The coil assembly 240 includes a magnetic core 244 (e.g., ferrite core) and a coil 246 wound thereon. The movable contactor 242 is coupled to a pin or shaft 248, which extends through the barrier 216, and is operably associated with the coil assembly 240. A biasing mechanism 250 (e.g., a spring) may be coupled to at least one of the barrier 216, the movable contactor 242, and the shaft 248. The biasing mechanism 250 is configured to bias the movable contactor 242 into a first position (e.g., out of contact with the fixed contactors 202, 204).

In the example embodiment, the voltage sampler 208 is integrated into the relay assembly 138 (e.g., housing 300) and is configured to measure the voltage on the fixed electrical contactors 202, 204. The voltage sampler 208 generally includes an electrical connector 260 electrically connected to a pair of voltage measurement lines 262, 264 (e.g., metal sheets, such as copper). In the example embodiment, at least a portion of the voltage measurement lines 262, 264 are disposed within one or more walls of the housing 200 (e.g., sidewall, top wall 220). However, it will be appreciated that at least a portion of the voltage measurement lines 262, 264 may be disposed within contactor compartment 214 and/or be exterior to housing 300. The first voltage measurement line 262 is electrically coupled to the first fixed contactor 202 via an electrical terminal 266, and the second voltage measurement line 264 is electrically coupled to the second fixed contactor 204 via an electrical terminal 268. The electrical connector 260 is in signal communication with the BMS 152 (or other ECU, controller, etc.) via a wire harness 270 and provides voltage sampling signals thereto. In this way, the voltage sampler 208 is configured to determine a voltage on each of the fixed contactors 202, 204 and send a signal indicative thereof to the BMS 152.

Additionally, in the example embodiment, the relay control 210 is configured to selectively provide a control current to the movable contactor assembly 206 to thereby move the movable contactor 242 into and out of contact with the fixed contactors 202, 204. The relay control 210 is in signal communication with the BMS 152 (or other ECU, controller, etc.) via the wire harness 270 (or other connection) to receive control signals for operation of the movable contactor assembly 206 and provide relay status signals to the BMS 152.

In an example operation, a control current is provided to coil 246 to create a magnetic field with the magnetic core 244. This magnetic field is configured to push or pull the shaft 248 to move the movable contactor 242 into and out of contact with the fixed contactors 202, 204 to selectively establish an electrical connection therebetween. The electrical connector 260 is configured to sample voltage via the voltage measurement lines 262, 264 and sends voltage value signals to the BMS 152 to provide a status of the relay assembly 138 (e.g., open or closed).

Accordingly, the relay assembly 138 is configured to selectively establish an electrical connection between the HV battery pack 130 and the HV bus 132. The relay assembly 138 advantageously integrates voltage sampler 208, which reduces parts and complexity, and obviates the need for a separate voltage sample function in the HV battery system 112.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A relay assembly of a battery disconnect unit (BDU) of an electrified vehicle high voltage (HV) battery system, comprising:
a housing defining a contactor compartment and a coil compartment separated by a barrier;
a first fixed contactor at least partially disposed within the contactor compartment and configured as an input to the relay assembly;
a second fixed contactor at least partially disposed within the contactor compartment and configured as an output of the relay assembly;
a movable contactor assembly configured to selectively electrically connect the first fixed contactor and the second fixed contactor; and
an integrated voltage sampler configured to measure a voltage on the first and second fixed contactors.

2. The relay assembly of claim 1, wherein the voltage sampler includes a pair of voltage measurement lines electrically connected to the first and second fixed contactors.

3. The relay assembly of claim 2, wherein the voltage sampler further includes an electrical connector electrically coupled to the pair of voltage measurement lines, wherein the electrical connector is configured to provide one or more signals indicative of the measured voltage.

4. The relay assembly of claim 2, wherein at least a portion of each voltage measurement line is disposed within a wall of the housing.

5. The relay assembly of claim 2, wherein each voltage measurement line is a metallic sheet.

6. The relay assembly of claim 1, further comprising a relay control configured to selectively provide a control current to the movable contactor assembly.

7. The relay assembly of claim 1, wherein the first and second fixed contactors extend through the housing into the contactor compartment.

8. The relay assembly of claim 1, wherein the movable contactor assembly comprises:
a coil assembly; and
a movable contactor configured to selectively move into contact with the first and second fixed contactors when the coil assembly is energized.

9. The relay assembly of claim 8, wherein the coil assembly includes a magnetic core with a coil wound thereon, and
wherein the movable contactor is coupled to a pin that extends through the barrier and into the coil assembly.

10. A high voltage (HV) battery system for an electrified vehicle, the HV battery system comprising:
a HV battery;
a HV bus configured to provide power to an electric drive module (EDM); and
a battery disconnect unit (BDU) having a relay assembly configured to selectively connect the HV battery to the HV bus, wherein the relay assembly includes an integrated voltage sampler configured to measure a voltage on the relay assembly.

11. The HV battery system of claim 10, wherein the relay assembly further comprises:
a housing defining a contactor compartment and a coil compartment separated by a barrier;
a first fixed contactor at least partially disposed within the contactor compartment and configured as an input to the relay assembly;
a second fixed contactor at least partially disposed within the contactor compartment and configured as an output of the relay assembly; and
a movable contactor assembly configured to selectively electrically connect the first fixed contactor and the second fixed contactor,
wherein the integrated voltage sampler is configured to measure a voltage on the first and second fixed contactors.

12. The HV battery system of claim 11, wherein the voltage sampler includes a pair of voltage measurement lines electrically connected to the first and second fixed contactors.

13. The HV battery system of claim 12, wherein the voltage sampler further includes an electrical connector electrically coupled to the pair of voltage measurement lines, wherein the electrical connector is configured to provide one or more signals indicative of the measured voltage.

14. The HV battery system of claim 13, further comprising a battery management system (BMS) controller in signal communication with the voltage sampler electrical connector.

15. The HV battery system of claim 12, wherein at least a portion of each voltage measurement line is disposed within a wall of the housing.

16. The HV battery system of claim 12, wherein each voltage measurement line is a metallic sheet.

17. The HV battery system of claim 10, further comprising a relay control configured to selectively provide a control current to the movable contactor assembly.

18. The HV battery system of claim 10, wherein the first and second fixed contactors extend through the housing into the contactor compartment.

19. The HV battery system of claim 10, wherein the movable contactor assembly comprises:
a coil assembly; and
a movable contactor configured to selectively move into contact with the first and second fixed contactors when the coil assembly is energized.

20. The HV battery system of claim 19, wherein the coil assembly includes a magnetic core with a coil wound thereon, and
wherein the movable contactor is coupled to a pin that extends through the barrier and into the coil assembly.
